(19) United States
(12) Patent Application Publication
(10) Pub. No.: US 2021/0047867 A1
(43) Pub. Date: Feb. 18, 2021

(54) LOCKING DEVICE AND LOCKING FRAME

(71) Applicant: Hangzhou Golden Sun Auto Parts Co., Ltd., Hangzhou (CN)

(72) Inventors: Feng WANG, Hangzhou (CN); Shaoyong ZHENG, Hangzhou (CN); Chenshan LIN, Hangzhou (CN); Jinqin FU, Hangzhou (CN); Peng CAO, Hangzhou (CN); Xue'e WANG, Hangzhou (CN)

(21) Appl. No.: 16/742,512

(22) Filed: Jan. 14, 2020

(30) Foreign Application Priority Data
Aug. 14, 2019 (CN) 201910750190.1

(51) Int. Cl. E05B 77/38; E05B 15/02; E05B 85/04

(52) U.S. Cl. CPC E05B 77/38; E05B 85/04; E05B 15/022

(57) ABSTRACT

A locking device includes a lock block assembly including a first locking structure and a first shock-absorption structure in a first direction; and a connector assembly including a second locking structure, and the second locking structure is clamped into the first locking structure to lock the lock block assembly and the connector assembly. A locking frame includes the locking device, a first sideboard, and a second sideboard, the lock block assembly is slidably mounted on the first sideboard; and the connector assembly is slidably mounted on the second sideboard. The locking device and the locking frame can only include the lock block assembly and the connector assembly, thereby being simple in structure.

### CROSS-REFERENCE TO RELATED APPLICATIONS

This Non-provisional application claims priority under 35 U.S.C. § 119(a) on Chinese Patent Application No(s). 201910750190.1 filed on Aug. 14, 2019, the entire contents of which are hereby incorporated by reference.

### BACKGROUND OF THE INVENTION

### Technical Field

The invention relates to a technical field of locks, in particular to a locking device and a locking frame.

### Description of Related Art

With the development of the economy, people are paying increased attention to personal safety and property safety. As a result, various locks appear in the market. However, existing locks cannot be locked smoothly due to the lack of a shock-absorption structure, and consequentially, the life of the locks is severely affected.

In addition, the whole lock cylinder of the existing locks is difficult to assemble and high in production cost; a lock shaft may collide with a stepped guide column during locking and unlocking, which in turn causes step jumps of the lock shaft, and a sense of unsmoothness is caused during contact.

### SUMMARY OF THE INVENTION

The object of the invention is to provide a locking device and a locking frame without or reducing the jerk in a locking process.

In view of the above problems, the present invention provides a locking device, including:

a lock block assembly including a first locking structure and a first shock-absorption structure in a first direction; and

a connector assembly including a second locking structure, and the second locking structure is clamped into the first locking structure to lock the lock block assembly and the connector assembly.

Optionally, the first shock-absorption structure may include a first spring and a shock-absorption block, the shock-absorption block and one end of the first locking structure cooperate to form a first cavity used for receiving the first spring, and the two ends of the first spring respectively abut against the shock-absorption block and the first locking structure.

Optionally, the first shock-absorption structure further may include a first connecting piece, and the first connecting piece penetrates through the shock-absorption block to be connected to one end of the first locking structure to fasten the shock-absorption block and the first locking structure.

Optionally, the connector assembly further may include a second shock-absorption structure in a second direction, the second direction may be perpendicular to the first direction; the second shock-absorption structure may include a second spring and a connector, the connector and one end of the second locking structure cooperate to form a second cavity used for receiving the second spring, and the two ends of the second spring respectively abut against the connector and the second locking structure.

Optionally, the second shock-absorption structure further may include a second connecting piece, and the second connecting piece penetrates through the connector to be connected to one end of the second locking structure to fasten the connector and the second locking structure.

Optionally, the first locking structure may be provided with a first groove, and the other end of the second locking structure may be clamped into the first groove to lock the lock block assembly and the connector assembly.

Optionally, the connector assembly further may include a positioning shaft, the first locking structure may be provided with a second groove, the positioning shaft slides into the second groove to clamp the lock block assembly and the connector assembly; the positioning shaft may be rotatably arranged in the second groove, and the other end of the second locking structure can be aligned to and positioned in the first groove by rotation of the positioning shaft.

Optionally, the second groove and the first groove are respectively arranged at two sides of the first locking structure.

Optionally, the other end of the second locking structure has a tangent surface, and the first groove has an inclined surface matched with the tangent surface.

Optionally, the second groove has a sliding surface, a circular groove and a protrusion, wherein the sliding surface may be connected with one end of the circular groove, the protrusion may be connected with the other end of the circular groove, and the positioning shaft slides into the circular groove through the sliding surface and may be then rotatably arranged into the circular groove.

The present invention also provides a locking frame, including:

a locking device including a lock block assembly and a connector assembly, wherein the lock block assembly includes a first locking structure and a first shock-absorption structure in a first direction; the connector assembly includes a second locking structure, and the second locking structure is clamped into the first locking structure to lock the lock block assembly and the connector assembly;

a first sideboard, wherein the lock block assembly is slidably mounted on the first sideboard; and

a second sideboard, wherein the connector assembly is slidably mounted on the second sideboard.

Optionally, the first shock-absorption structure may include a shock-absorption block, the shock-absorption block may further include a first connecting part, the first locking structure may include a second connecting part, the lock block assembly may be slidably connected with the first sideboard through the first connecting part and the second connecting part; the second shock-absorption structure may include a connector, the connector may include a third connecting part, the connector assembly may be slidably connected to the second sideboard through the third connecting part.

The locking device can only include the lock block assembly and the connector assembly, thereby being simple in structure. Moreover, the first shock-absorption structure is arranged at the lock block assembly, so that a sense of being stuck generated when the locking device is locked can be reduced. In addition, the first locking structure and the second locking structure are clamped to lock the lock block assembly and the connector assembly, and finally, a locking function of the locking device is realized without a complex structure such as a lock cylinder, so that the manufacturing cost is low.

### BRIEF DESCRIPTION OF THE DRAWINGS

FIG. 1 is a perspective view of a locking frame in an embodiment of the invention;

FIG. 2 is an exploded view of a lock block assembly in the embodiment of the invention;

FIG. 3 is a schematic diagram of a first shock-absorption structure in the embodiment of the invention;

FIG. 4 is a schematic diagram of a first locking structure in the embodiment of the invention;

FIG. 5 is an exploded view of a connector assembly in the embodiment of the invention;

FIG. 6 is a left view of a connector in the embodiment of the invention;

FIG. 7 is a top view of the locking frame in the embodiment of the invention;

FIG. 8 is a sectional view in A-A direction in FIG. 7;

FIG. 9 is another top view of the locking frame in the embodiment of the invention;

FIG. 10 is a sectional view in B-B direction in FIG. 9;

FIG. 11 is a top view of the locking frame in the locking process in the embodiment of the invention;

FIG. 12 is a sectional view in C-C direction in FIG. 11.

### DETAILED DESCRIPTION OF THE INVENTION

Specific implementations of the invention are further expounded below in combination with the accompanying drawings and embodiments. The following embodiments are used for explaining the invention, and are not used for limiting the scope of the invention.

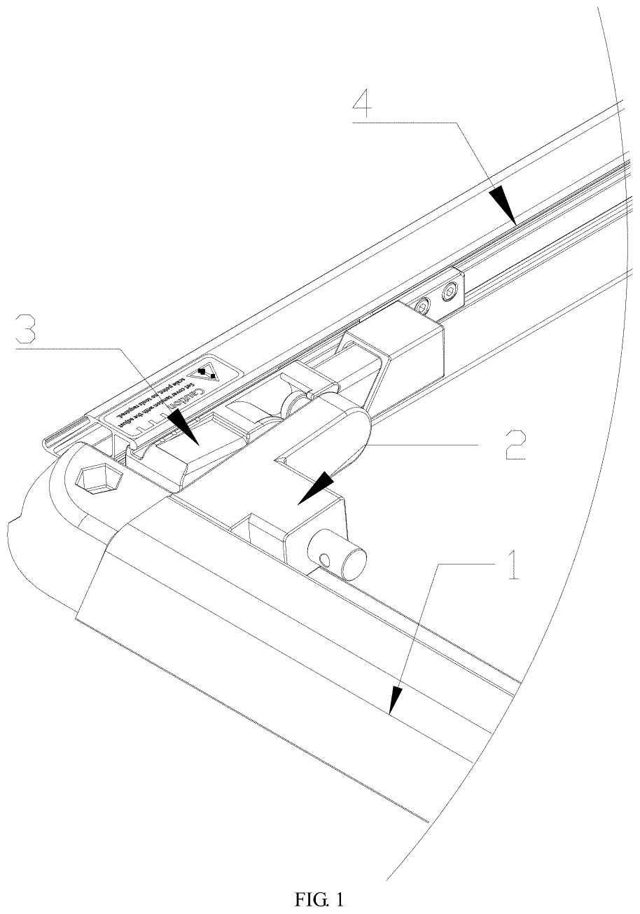

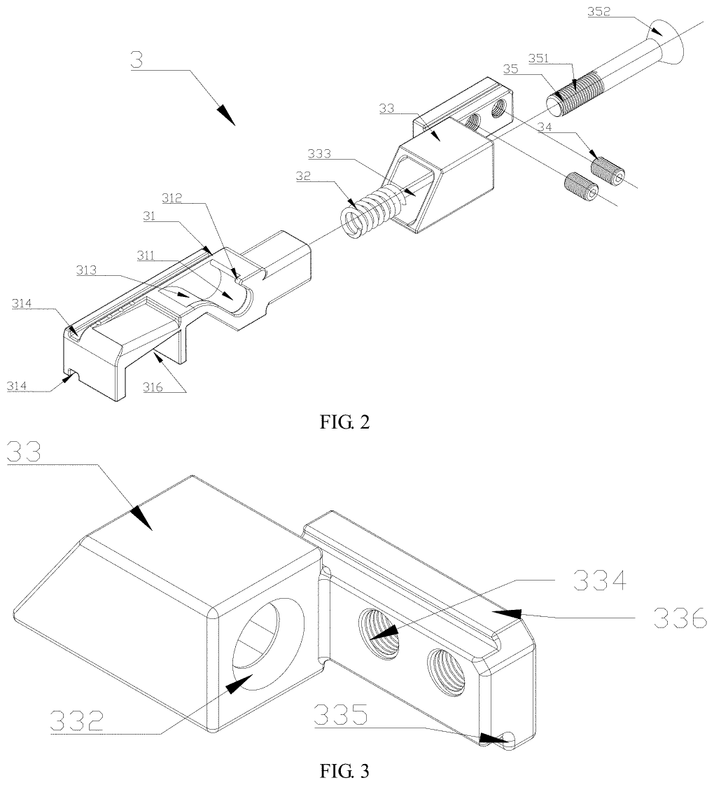

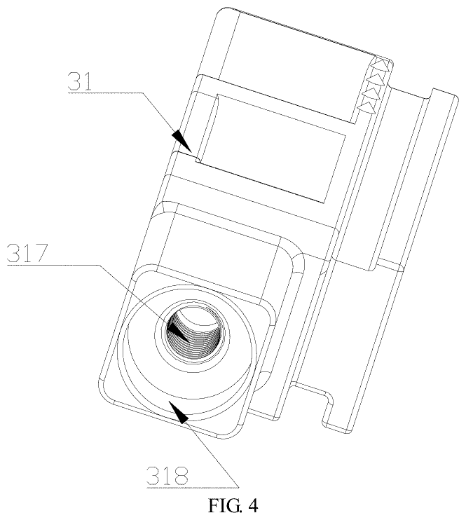

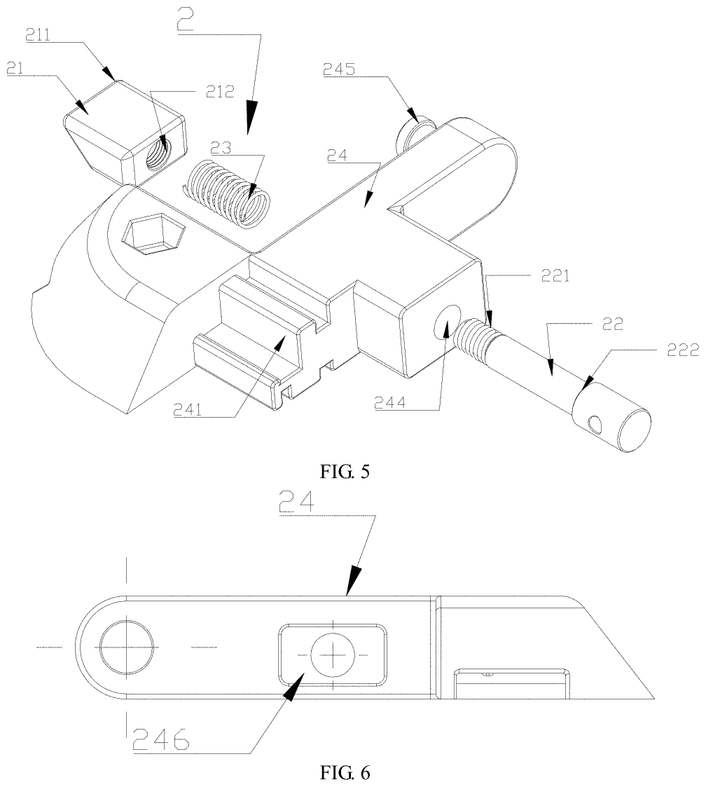

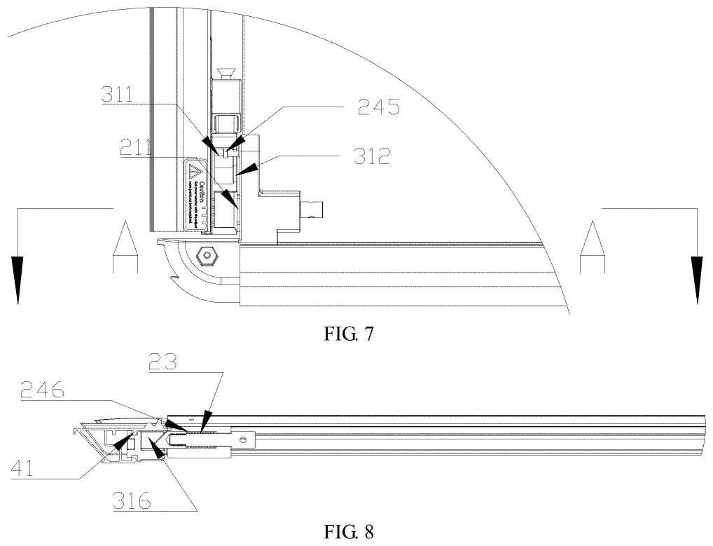

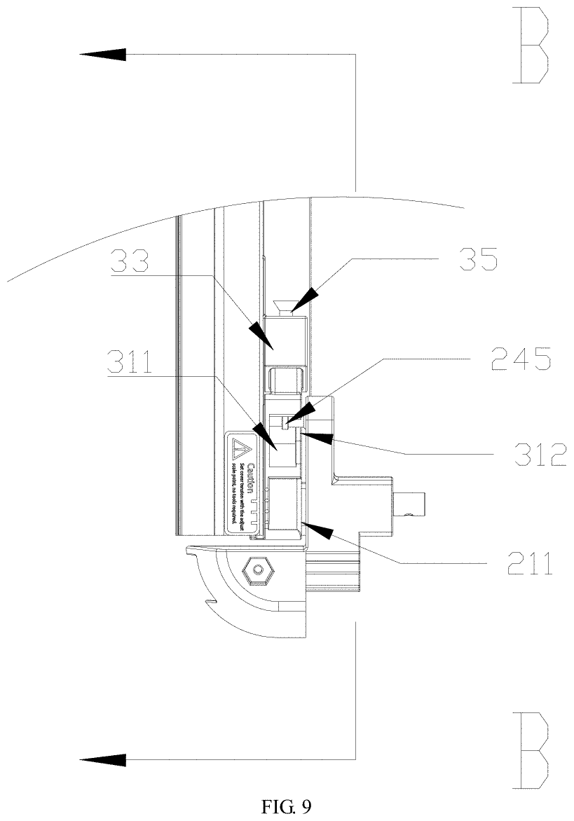

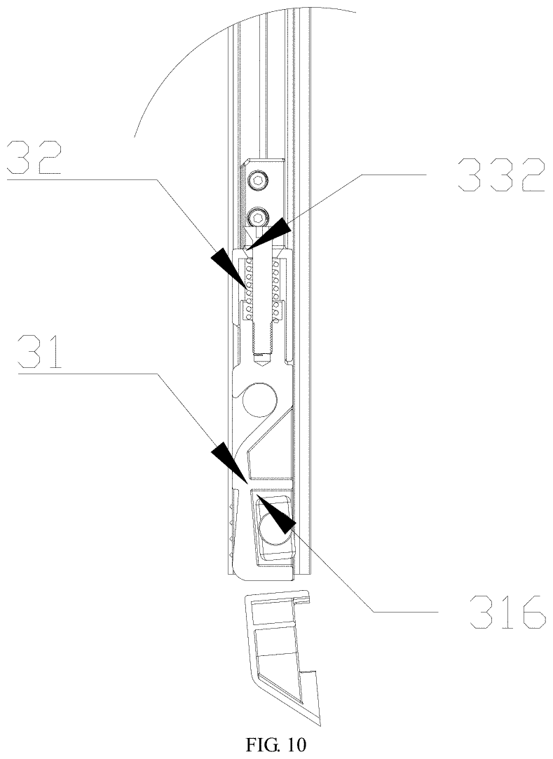

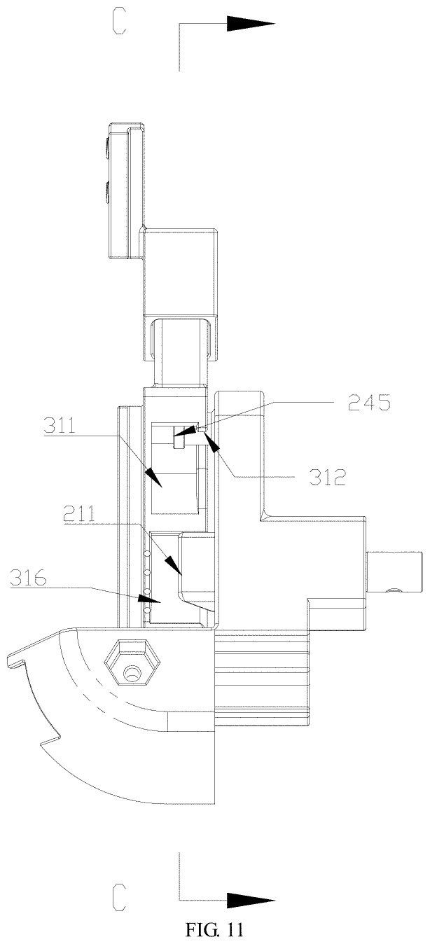

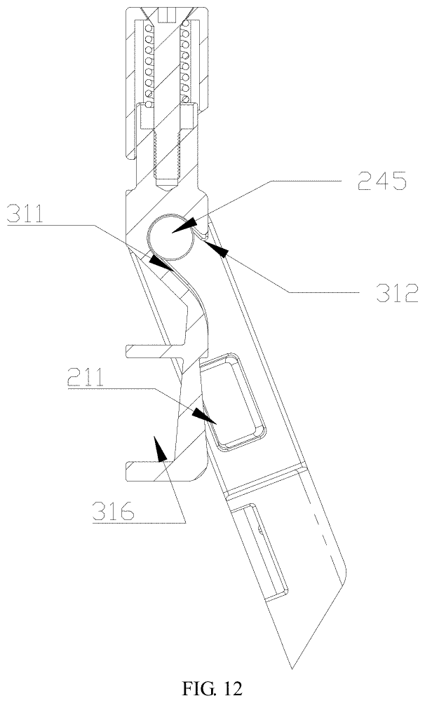

Referring to FIG. 1-FIG. 12, an embodiment of the invention provides a locking device. The locking device includes a lock block assembly 3 and a connector assembly 2. The lock block assembly 3 includes a first locking structure 31 and a first shock-absorption structure in a first direction. The connector assembly 2 includes a second locking structure 21, and the second locking structure 21 is clamped into the first locking structure 31 to lock the lock block assembly 3 and the connector assembly 2.

The locking device can only include the lock block assembly 3 and the connector assembly 2, thereby being simple in structure. Moreover, the first shock-absorption structure is arranged at the lock block assembly 3, so that a sense of being stuck generated when the locking device is locked can be reduced. In actual use, the first direction is parallel to a common moving direction of the locking device. For example, the first direction is parallel to the front-back moving direction of a vehicle. In other embodiments, an included angle may be formed between the first direction and the common moving direction of the locking device. In addition, the first locking structure 31 and the second locking structure 21 are clamped to lock the lock block assembly 3 and the connector assembly 2, and finally, a locking function of the locking device is realized without a complex structure such as a lock cylinder, so that the manufacturing cost is low.

More particularly, in this embodiment, the first locking structure 31 is provided with a first groove 316, and the other end of the second locking structure 21 is clamped in the first groove 316 to lock the lock block assembly 3 and the connector assembly 2; the other end of the second locking structure 21 has a tangent surface 211, and the first groove 316 has an inclined surface matched with the tangent surface 211; and when the other end of the second locking structure 21 slides with respect to the first groove 316, the inclined surface and the tangent surface 211 can tangentially slide to be closely clamped together. Furthermore, a sliding strip and a sliding groove matched with the sliding strip may be separately arranged at the inclined surface and the tangent surface 211 to further facilitate the sliding of the other end of the second locking structure 21 with respect to the first groove 316.

In this embodiment, the connector assembly 2 further includes a positioning shaft 245, the first locking structure 31 is provided with a second groove 311, and the positioning shaft 245 slides into the second groove 311 to clamp the lock block assembly 3 and the connector assembly 2; and the positioning shaft 245 is rotatably arranged in the second groove 311, and the other end of the second locking structure 21 can be aligned to and positioned in the first groove 316 by rotation of the positioning shaft 245. More particularly, the second groove 311 has a sliding surface 313, a circular groove and a protrusion 312, wherein the sliding surface 313 is connected with one end of the circular groove, the protrusion 312 is connected with the other end of the circular groove, and the positioning shaft 245 slides into the circular groove through the sliding surface 313 and is then rotatably arranged in the circular groove. The sliding surface 313 is able to limit the sliding direction of the positioning shaft 245. In this embodiment, the protrusion 312 protrudes towards the interior of the circular groove to prevent the positioning shaft 245 from sliding out of the circular groove. Furthermore, the sliding surface 313 can be in a step shape to further prevent the positioning shaft 245 from sliding out of the circular groove. Dual positioning and clamping are realized through the first groove 316 and the second locking structure 21 as well as through the second groove 311 and the positioning shaft 245.

In this embodiment, the second groove 311 and the first groove 316 are respectively formed in two sides of the first locking structure 31. The positioning shaft 245 and the other end of the second locking structure 21 are respectively located on two sides of the second locking structure 21. When the lock block assembly 3 and the connector assembly 2 are to be locked, the positioning shaft 245 is slid into the circular groove through the sliding surface 313 first, and then the positioning shaft 245 in the second groove 311 is rotated until the other end of the second locking structure 21 is aligned to and positioned in the first groove 316; and afterwards, the other end of the second locking structure 21 slides with respect to the first groove 316 to be closely clamped in the first groove 316.

In other embodiments, the first locking structure 31 and the second locking structure 21 may be a groove and a lug matched with the groove. Or, the first locking structure 31 and the second locking structure 21 are structures which have sawtoothed, patterned or stepped surfaces and can slide relatively to be clamped together. Or, the first locking structure 31 and the second locking structure 21 are respectively a hole and a shaft matched with the hole, or the combinations of any structures, including a groove and a lug matched with the groove, as well as a hole and a shaft matched with the hole and capable of rotating in the hole, wherein the lug can be clamped in the groove by rotation of the shaft in the hole; or, including a groove and a lug matched with the groove, as well as the structures having sawtoothed, patterned or stepped surfaces, wherein the lug can be clamped in the groove by relative sliding of the sawtoothed, patterned or stepped surfaces.

In this embodiment, the first shock-absorption structure includes a first spring 32 and a shock-absorption block 33, wherein the shock-absorption block 33 is matched with one end of the first locking structure 31 to form a first cavity 333 used for receiving the first spring 32, and the two ends of the first spring 32 respectively abut against the shock-absorption block 33 and the first locking structure 31, so that the first spring 32 is limited in the first cavity 333. One end of the first locking structure 31 is arranged in the first cavity 333. A shock-absorption mechanism is formed by one end of the first locking structure 31, the first spring 32 and the shock-absorption block 33. The end, close to the first locking structure 31, of the shock-absorption block 33 has an inclined surface. One end of the first locking structure 31 is provided with a groove 318 abutting against the first spring 32.

In this embodiment, the first shock-absorption structure further includes a first connecting piece 35, and the first connecting piece 35 penetrates through the shock-absorption block 33 to be connected to one end of the first locking structure 31, so that the shock-absorption block 33 and the first locking structure 31 are fastened. The first connecting piece 35 is arranged in the first spring 32. In this embodiment, the first connecting piece 35 is a guide screw, one end of the guide screw is provided with a thread 351, one end of the first locking structure 31 is provided with a threaded hole 317 matched with the thread of the guide screw, the other end of the guide screw is provided with a conical part 352, the end, close to the first connecting piece 35, of the shock-absorption block 33 is provided with a conical hole 332 matched with the conical part 352, the conical hole 332 is communicated with the first cavity 333, and after the first connecting piece 35 penetrates through the shock-absorption block 33 to be connected with the thread at one end of the first locking structure 31, the conical part 352 is exactly located in the conical hole to fulfill a limiting function; and at this moment, one end of the first locking structure 31 is located in the first cavity 333.

In the locking process, when the positioning shaft 245 is slid into the second groove 311, the first locking structure 31 pushes the first spring 32 to move in the first direction under the mutual effect of the positioning shaft 245 and the first locking structure 31, so that a sense of unsmoothness generated during locking is reduced. After locking, the spring has a tendency to move reversely under the effect of its elastic force and thus is tensioned, so that the positioning shaft 245 keeps being locked in the second groove 311.

In this embodiment, the connector assembly 2 further includes a second shock-absorption structure in a second direction, wherein the second direction is perpendicular to the first direction; the second shock-absorption structure includes a second spring 23 and a connector 24, and the connector 24 is matched with one end of the second locking structure 21 to form a second cavity 246 used for receiving the second spring 23, and the two ends of the second spring 23 respectively abut against the connector 24 and the second locking structure 21. One end of the second locking structure 21 is arranged in the second cavity 246. A shock-absorption mechanism is formed by one end of the second locking structure 21, the second spring 23 and the connector 24.

In other embodiments, the second direction may be any other direction not parallel to the first direction. The second connecting piece 22 is arranged in the second spring 23. In this embodiment, the second connecting piece 22 is a guide connecting rod, one end of the guide connecting rod is provided with a thread 221, one end of the second locking structure 21 is provided with a threaded hole 212 matched with the thread of the guide connecting rod, the other end of the guide connecting rod is provided with a limit block 222, the end, close to the second connecting piece 22, of the connector 24 is provided with a limit hole 244 matched with the limit block 222, the limit hole 244 is communicated with the second cavity 246, and after the second connecting piece 22 penetrates through the connector 24 to be connected to the thread at one end of the second locking structure 21, the limit block exactly abuts against the connector 24 to fulfill a limiting function; and at this moment, one end of the second locking structure 21 is arranged in the second cavity 246.

In the locking process, when the second locking structure 21 is slid into the first groove 316, the second locking structure 21 pushes the second spring 23 to move in the second direction under the mutual effect of the second locking structure 21 and the second groove 311, so that a sense of unsmoothness generated during locking is reduced. After locking, the spring has a tendency to move reversely (reverse direction of the second direction) under the effect of its elastic force and thus is tensioned, so that the second locking structure 21 keeps being locked in the first groove 316.

An embodiment of the invention further provides a locking frame. The locking frame includes the locking device mentioned above, a first sideboard 4 and a second sideboard 1. In this embodiment, the first sideboard 4 and the second sideboard 1 are respectively a lateral sideboard and a rear sideboard of a vehicle. The lock block assembly 3 is slidably mounted on the first sideboard 4. The connector assembly 2 is slidably mounted on the second sideboard 1. Furthermore, the shock-absorption block 33 further includes a first connecting part 335, the first locking structure 31 includes a second connecting part 314, and the lock block assembly 3 is slidably connected with the first sideboard 4 through the first connecting part 335 and the second connecting part 314; and grooves are formed in upper and lower ends of the first connecting part 335, the first sideboard 4 is provided with protruding parts matched with the grooves, and the protruding parts are slidably arranged in the grooves of the first connecting part 335. The second connecting part 314 is provided with grooves matched with the protruding parts to make sure that the first locking structure 31 is slidably connected to the first sideboard 4. The locking frame further includes a fixing block 336 provided with a threaded hole, a screw penetrates through the threaded hole to abut against the first sideboard 4, and thus, the fixing block 336 is fixed to the first sideboard 4. The fixing block 336 is used for retraining the sliding of the shock-absorption block 33 on the first sideboard 4, so that a limiting function is realized. In other embodiments, the fixing block 336 and the shock-absorption block 33 can be integrally arranged and fixedly connected. The connector 24 includes a third connecting part 241, and the connector assembly 2 is slidably connected to the second sideboard 1 through the third connecting part 241. These sliding structures guarantee that the first locking structure 31 and the shock-absorption block 33 can move relatively, and deformation of the first spring 32 and the second spring 23 is realized by relative movement of the second locking structure 21 and the connector 24, so that a shock-absorption function is realized finally.

It should be understood by those skilled in the art that in the disclosure of the invention, the direction or position relationship indicated by the terms “up”, “down”, “front”, “back”, “left”, “right”, “vertical”, “horizontal”, “top”, “bottom”, “inside”, “outside” is based on the direction or position relationship shown in the drawings, which is only for the convenience of describing the invention and simplifying the description, rather than indicating or implying that the device or element referred to must have a specific orientation, be constructed and operated in a specific orientation, so the above term cannot be understood as a limitation of the invention.

Although the invention has been disclosed by a preferred embodiment as above, it is not used to define the invention. Anyone who is familiar with the art can make some changes and refinements within the spirit and scope of the invention. Therefore, the scope of protection of the invention shall be subject to the scope of protection required by the claims.

What is claimed is:

1. A locking device, comprising:
a lock block assembly comprising a first locking structure and a first shock-absorption structure in a first direction; and
a connector assembly comprising a second locking structure, and the second locking structure is clamped into the first locking structure to lock the lock block assembly and the connector assembly.

2. The locking device according to claim 1, wherein the first shock-absorption structure comprises a first spring and a shock-absorption block, the shock-absorption block and one end of the first locking structure cooperate to form a first cavity used for receiving the first spring, and the two ends of the first spring respectively abut against the shock-absorption block and the first locking structure.

3. The locking device according to claim 2, wherein the first shock-absorption structure further comprises a first connecting piece, and the first connecting piece penetrates through the shock-absorption block to be connected to one end of the first locking structure to fasten the shock-absorption block and the first locking structure.

4. The locking device according to claim 1, wherein the connector assembly further comprises a second shock-absorption structure in a second direction, the second direction is perpendicular to the first direction; the second shock-absorption structure comprises a second spring and a connector, the connector and one end of the second locking structure cooperate to form a second cavity used for receiving the second spring, and the two ends of the second spring respectively abut against the connector and the second locking structure.

5. The locking device according to claim 4, wherein the second shock-absorption structure further comprises a second connecting piece, and the second connecting piece penetrates through the connector to be connected to one end of the second locking structure to fasten the connector and the second locking structure.

6. The locking device according to claim 1, wherein the first locking structure is provided with a first groove, and the other end of the second locking structure is clamped into the first groove to lock the lock block assembly and the connector assembly.

7. The locking device according to claim 6, wherein the connector assembly further comprises a positioning shaft, the first locking structure is provided with a second groove, the positioning shaft slides into the second groove to clamp the lock block assembly and the connector assembly; the positioning shaft is rotatably arranged in the second groove, and the other end of the second locking structure can be aligned to and positioned in the first groove by rotation of the positioning shaft.

8. The locking device according to claim 7, wherein the second groove and the first groove are respectively arranged at two sides of the first locking structure.

9. The locking device according to claim 6, wherein the other end of the second locking structure has a tangent surface, and the first groove has an inclined surface matched with the tangent surface.

10. The locking device according to claim 7, wherein the second groove has a sliding surface, a circular groove and a protrusion, wherein the sliding surface is connected with one end of the circular groove, the protrusion is connected with the other end of the circular groove, and the positioning shaft slides into the circular groove through the sliding surface and is then rotatably arranged into the circular groove.

11. A locking frame, comprising:
a locking device comprising a lock block assembly and a connector assembly, wherein the lock block assembly comprises a first locking structure and a first shock-absorption structure in a first direction; the connector assembly comprises a second locking structure, and the second locking structure is clamped into the first locking structure to lock the lock block assembly and the connector assembly;
a first sideboard, wherein the lock block assembly is slidably mounted on the first sideboard; and
a second sideboard, wherein the connector assembly is slidably mounted on the second sideboard.

12. The locking frame according to claim 11, wherein the first shock-absorption structure comprises a shock-absorption block, the shock-absorption block further comprises a first connecting part, the first locking structure comprises a second connecting part, the lock block assembly is slidably connected with the first sideboard through the first connecting part and the second connecting part; the second shock-absorption structure comprises a connector, the connector comprises a third connecting part, the connector assembly is slidably connected to the second sideboard through the third connecting part.

13. The locking device according to claim 2, wherein the connector assembly further comprises a second shock-absorption structure in a second direction, the second direction is perpendicular to the first direction; the second shock-absorption structure comprises a second spring and a connector, the connector and one end of the second locking structure cooperate to form a second cavity used for receiving the second spring, and the two ends of the second spring respectively abut against the connector and the second locking structure.

14. The locking device according to claim 3, wherein the connector assembly further comprises a second shock-absorption structure in a second direction, the second direction is perpendicular to the first direction; the second shock-absorption structure comprises a second spring and a connector, the connector and one end of the second locking structure cooperate to form a second cavity used for receiving the second spring, and the two ends of the second spring respectively abut against the connector and the second locking structure.

15. The locking device according to claim 2, wherein the first locking structure is provided with a first groove, and the other end of the second locking structure is clamped into the first groove to lock the lock block assembly and the connector assembly.

16. The locking device according to claim 3, wherein the first locking structure is provided with a first groove, and the other end of the second locking structure is clamped into the first groove to lock the lock block assembly and the connector assembly.

17. The locking frame according to claim 11, wherein the first locking structure is provided with a first groove, and the other end of the second locking structure is clamped into the first groove to lock the lock block assembly and the connector assembly.

18. The locking frame according to claim 17, wherein the connector assembly further comprises a positioning shaft, the first locking structure is provided with a second groove, the positioning shaft slides into the second groove to clamp the lock block assembly and the connector assembly; the positioning shaft is rotatably arranged in the second groove, and the other end of the second locking structure can be aligned to and positioned in the first groove by rotation of the positioning shaft.

19. The locking frame according to claim 17, wherein the other end of the second locking structure has a tangent surface, and the first groove has an inclined surface matched with the tangent surface.

20. The locking frame according to claim 18, wherein the second groove has a sliding surface, a circular groove and a protrusion, wherein the sliding surface is connected with one end of the circular groove, the protrusion is connected with the other end of the circular groove, and the positioning shaft slides into the circular groove through the sliding surface and is then rotatably arranged into the circular groove.
